(19) United States
(12) Patent Application Publication
(10) Pub. No.: US 2024/0106906 A1
(43) Pub. Date: Mar. 28, 2024

(54) ACCUMULATED RESOURCE ACCESS USING REQUEST-TO-TRANSFER

(71) Applicant: The Toronto-Dominion Bank, Toronto (CA)

(72) Inventors: Milos DUNJIC, Oakville (CA); David Samuel TAX, Toronto (CA); Kushank RASTOGI, Toronto (CA)

(73) Assignee: The Toronto-Dominion Bank, Toronto (CA)

(21) Appl. No.: 17/953,695

(22) Filed: Sep. 27, 2022

(51) Int. Cl. H04L 67/00; G06Q 40/04

(52) U.S. Cl. CPC H04L 67/34; G06Q 40/04

(57) ABSTRACT

A method may include: detecting a predicted resource availability condition associated with a first account by determining that an accumulated resource amount associated with a resource transfer expected to be scheduled to occur at a future time is expected to be available; in response to detecting the predicted resource availability condition, providing a selectable interface feature on a computing device, the selectable interface feature configured for inputting an early access instruction to request immediate release of at least a portion of the accumulated resource amount; receiving the early access instruction; and in response to receiving the early access instruction, sending a request-to-transfer message to a second account, the second account identified as being associated with the resource transfer expected to be scheduled to occur, the request-to-transfer message requesting a transfer of an amount of resources that is less than or equal to the accumulated resource amount.

### TECHNICAL FIELD

The present application relates to accumulated resource access systems and, more particularly, to methods and systems which allow for early access to accumulated resources before a scheduled transfer date.

### BACKGROUND

User accounts may receive regularly scheduled replenishments; for instance, a mobile connectivity account may have a monthly data allocation, a computing resources account may have a monthly server time allocation, or a bank account may have a regular income deposit (e.g. payroll payment). In some cases, systems may exist to enable a user or administrator to receive an early allocation of resources before the scheduled replenishment, i.e. an “advance” of resources. For example, in the case of payroll, some services exist that, in concert with a payroll system, make wages available earlier than the regular payroll processing schedule. That is, an employee may request early access to earned wages. One example of such a system is DailyPay™ of New York, US.

Early resource access systems require interoperability and integration between a number of different computing systems. For example, early resource access systems that provide early access to payroll typically require integration with a payroll computer system and a time tracking computer system so that the early resource access system may determine the number of hours that a particular employee has worked since a last transfer and to ensure that the payroll computer system accounts for any early wages provided to prevent the payroll computer system from double paying the employee. Such integrations between computing systems present numerous obstacles, particularly when many of the systems are legacy systems that do not allow for easy exposure of data. Further, early resource access systems typically rely upon special interfaces, such as an application programming interface (API) which other systems must be configured to use in order to make use of early resource access systems.

The computing problems associated with implementing early resource access systems, such as earned wage access systems, have been so difficult to overcome that only large employers have typically launched such systems. Few small employers are able to accommodate the computing burden of updating legacy systems to operate with early resource access systems.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a computing device;

FIG. 3 is a high-level schematic diagram of an example computer device;

FIG. 4 shows a simplified organization of software components stored in a memory of the example computer device of FIG. 3;

FIG. 5 shows a flowchart showing operations performed by a first database management system in requesting early access to an accumulated resource;

FIG. 6 is an example account management interface displayed when accumulated resources are available according to an embodiment;

FIG. 7 is an example notification provided on a transferor device in response to receiving a request-to-transfer in accordance with an embodiment;

FIG. 8 is a further example account management interface displayed after accumulated resources have been accessed according to an embodiment; and

FIG. 9 is a flowchart showing operations performed by a first database management system in requesting early access to an accumulated resource in accordance with an embodiment.

Like reference numerals are used in the drawings to denote like elements and features.

### DETAILED DESCRIPTION OF VARIOUS EMBODIMENTS

In accordance with one aspect of the present invention, there is provided a computing system. The computing system may include a communications module. The computing system may include a processor coupled to the communications module. The computing system may include a memory coupled to the processor. The memory may store instructions that, when executed by the computing system, cause the computing system to: detect a predicted resource availability condition associated with a first account by determining, based on a transfer history, that an accumulated resource amount associated with a resource transfer expected to be scheduled to occur at a future time is expected to be available for immediate access; in response to detecting the predicted resource availability condition, provide a selectable interface feature at a user interface on a computing device associated with the first account, the selectable interface feature configured for inputting an early access instruction to request immediate release of at least a portion of the accumulated resource amount; receive the early access instruction; and in response to receiving the early access instruction, send a request-to-transfer message to a second account, the second account identified as being associated with the resource transfer expected to be scheduled to occur, the request-to-transfer message requesting a transfer of an amount of resources that is less than or equal to the accumulated resource amount.

In some implementations, the instructions further configure the computing system to receive, at the first account and from the second account, a first transfer in the requested amount.

In some implementations, the instructions further cause the computing system to, after receiving the first transfer: receive, at the first account and from the second account, a second transfer, the second transfer for a further amount; and in response to receiving the second transfer, automatically initiate a transfer to reverse the first transfer.

In some implementations, the transfer to reverse the first transfer may be made without any interaction from any operator and without permitting an account-holder for the first account to prevent the transfer to reverse the first transfer.

In some implementations, the request-to-transfer message includes an identifier for the first account to allow for verification of the request-to-transfer message.

In some implementations, detecting a predicted resource availability condition associated with a first account includes determining the accumulated resource amount based on: a last date for a recurring transfer from the second account to the first account; an amount of one or more past transfers from the second account to the first account; and a determined period between the recurring transfers.

In some implementations, determining the accumulated resource amount includes determining a portion of the resource transfer expected to be scheduled to occur at a future time that is attributable to current progress within the determined period.

In some implementations, the request-to-transfer message is sent from a first financial institution system to a second financial institution system.

In some implementations, the request-to-transfer message is a pre-staged transfer message that allows a transfer to be sent without input of a transfer amount.

In some implementations, the instructions further configure the computing system to identify the second account by identifying an account from which a recurring transfer into the first account has previously been made.

In yet another aspect, there is described a method. The method may include: detecting a predicted resource availability condition associated with a first account by determining, based on a transfer history, that an accumulated resource amount associated with a resource transfer expected to be scheduled to occur at a future time is expected to be available for immediate access; in response to detecting the predicted resource availability condition, providing a selectable interface feature at a user interface on a computing device associated with the first account, the selectable interface feature configured for inputting an early access instruction to request immediate release of at least a portion of the accumulated resource amount; receiving the early access instruction; and in response to receiving the early access instruction, sending a request-to-transfer message to a second account, the second account identified as being associated with the resource transfer expected to be scheduled to occur, the request-to-transfer message requesting a transfer of an amount of resources that is less than or equal to the accumulated resource amount.

In some implementations, the method may include receiving, at the first account and from the second account, a first transfer in the requested amount.

In some implementations, the method may include, after receiving the first transfer: receiving, at the first account and from the second account, a second transfer, the second transfer for a further amount; and in response to receiving the second transfer, automatically initiating a transfer to reverse the first transfer.

In some implementations of the method, the transfer to reverse the first transfer is made without any interaction from any operator and without permitting an account-holder for the first account to prevent the transfer to reverse the first transfer.

In some implementations of the method, the request-to-transfer message includes an identifier for the first account to allow for verification of the request-to-transfer message.

In some implementations of the method, detecting a predicted resource availability condition associated with a first account includes determining the accumulated resource amount based on: a last date for a recurring transfer from the second account to the first account; an amount of one or more past transfers from the second account to the first account; and a determined period between the recurring transfers.

In some implementations of the method, determining the accumulated resource amount includes determining a portion of the resource transfer expected to be scheduled to occur at a future time that is attributable to current progress within the determined period.

In some implementations of the method, the request-to-transfer message is sent from a first financial institution system to a second financial institution system.

In some implementations of the method, the request-to-transfer message is a pre-staged transfer message that allows a transfer to be sent without input of a transfer amount.

In some implementations, the method may further include identifying the second account by identifying an account from which a recurring transfer into the first account has previously been made.

In accordance with another aspect of the present invention, there is provided a non-transitory computer-readable storage medium storing instructions that when executed by a processor of a computing system cause the computing system to perform a method described herein. In one example, the computer-readable storage medium may store instructions that, when executed by a computing system, cause the computing system to: detect a predicted resource availability condition associated with a first account by determining, based on a transfer history, that an accumulated resource amount associated with a resource transfer expected to be scheduled to occur at a future time is expected to be available for immediate access; in response to detecting the predicted resource availability condition, provide a selectable interface feature at a user interface on a computing device associated with the first account, the selectable interface feature configured for inputting an early access instruction to request immediate release of at least a portion of the accumulated resource amount; receive the early access instruction; and in response to receiving the early access instruction, send a request-to-transfer message to a second account, the second account identified as being associated with the resource transfer expected to be scheduled to occur, the request-to-transfer message requesting a transfer of an amount of resources that is less than or equal to the accumulated resource amount.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, the term account or user account may be used interchangeably with “logical storage area” or “record” or “record in a database.”

In the present application, the terms “transferor” and “transferee” may be used interchangeably with “sender” and “recipient”, respectively, in the context of describing transfers of resources. In some cases, the terms “payor” or “payee” may be used in the example of monetary resources.

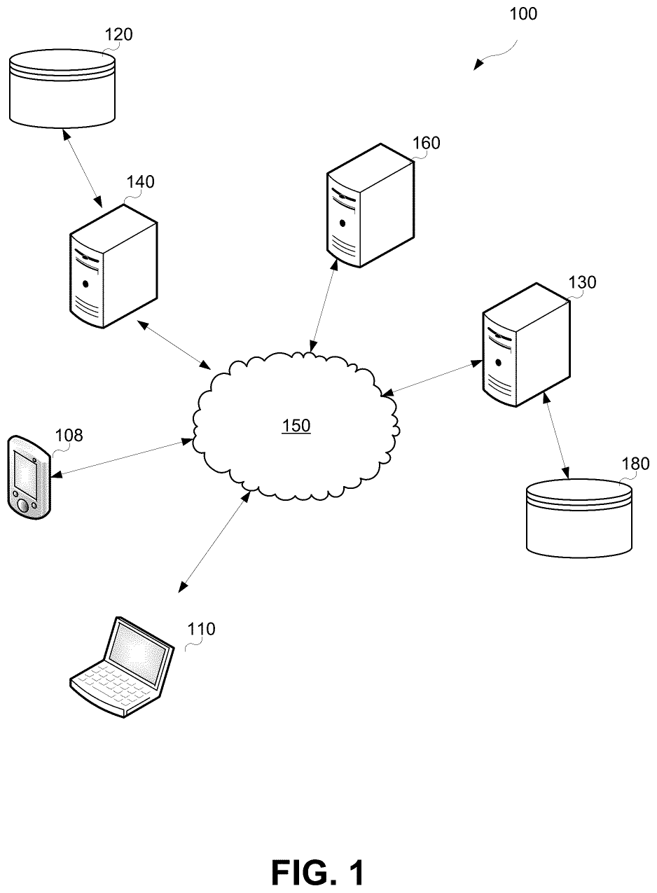

FIG. 1 is a block diagram illustrating an operating environment of an example embodiment. Various components cooperate to provide a system 100 which may be used, for example, to perform an operation. As shown, the system 100 includes a transferee device 108, a transferor device 110, a first database management system 130, and a second database management system 140 coupled to one another through a network 150, which may include a public network such as the Internet and/or a private network. The transferee device 108 is a computing device that may be associated with an entity, such as a user or client who is an employee of a first employer and who has a record in a database associated with and/or provided by the first database management system 130. The transferor device 110 is a computing device that may be associated with an entity, such as the employer of the employee. The employer has a record in a database associated with and provided by the second database management system 140. The records may also be referred to herein as logical storage areas.

The records may be or represent account data. The records may include data of various types and the nature of the data will depend on the nature of the first database management system 130 and the second database management system 140. By way of example, the records may reflect a resource balance and/or a transfer history.

By way of example, in some implementations, the first database management system 130 and the second database management system 140 may maintain user accounts and a record in the database may be or represent an account. The record may include or represent one or more resources. The resources may, for example, include computing resources, such as memory or processor cycles, bandwidth, data or memory usage, etc. By way of further example, the resources may include stored value, such as fiat currency, which may be represented in one or more databases. The resource may, in some implementations, be or include documents and/or other data stored by or on behalf of a user. By way of example, in an implementation, a user account may include documents or data uploaded by the user. Such documents and/or data may include, for example, any one or more of: images such as photographs, text-based documents, documents prepared according to a standardized file format, such as portable document format (PDF) documents, user preferences, digital identity data such as stored identity information or documentation, or other types of documents and/or data. For example, in an implementation, the first database management system and/or the second database management system may track, manage, maintain, and/or provide resources to associated entities. The resources may, for example, be computing resources, such as memory or processor cycles. By way of further example, the resources may include stored value, such as fiat currency, which may be represented in a database.

For example, the second database management system 140 may be coupled to a second database 120, which may be provided in secure storage. The secure storage may be provided internally within the second database management system 140 or externally. The secure storage may, for example, be provided remotely from the second database management system 140. For example, the secure storage may include one or more data centers. The data centers may, for example, store data with bank-grade security.

The second database 120 may include records associated with a plurality of entities. For example, the records may be for a plurality of accounts and at least some of the records may define a quantity of resources. For example, the entity that is associated with the transferor device 110, such as the employer, may be associated with an account having one or more records in the second database 120. The records may reflect a quantity of stored resources that are associated with the entity. Such resources may include owned resources and, in at least some embodiments, borrowed resources. The resources that are associated with an entity may be grouped into various buckets. Some such buckets may, for example, represent individual bank accounts. For example, an entity may be associated with one or more bank accounts. At least some of the resources may be borrowed resources. The borrowed resources may, for example, represent an amount of credit that is available to the entity. The entity that is associated with the transferor device 110 and the account may be a customer of a financial institution which operates or manages the second database management system 140. The term balance, as used herein, may refer to both owned resource balances and borrowed resource balances such as a credit limit.

The first database management system 130 and the second database management system 140 may be operated by different entities. That is, the first database management system 130 may be associated with a first system operator and the second database management system 140 may be associated with a second system operator who is different than the first system operator. The first database management system 130 may be, for example, associated with a financial institution server that is associated with a different financial institution than the second database management system 140 and may maintain customer financial accounts. That is, the second database management system 140 may maintain a second database 120 that includes various data records. A data record may, for example, reflect an amount of value stored in a particular account associated with a user.

The first database management system 130 may include or be connected with a first database 180 that operates similar to the second database 120 that is provided by or associated with the second database management system 140. One of the accounts maintained by the first database management system 130 may be associated with an employee of the employer having an account with the second database management system 140.

The first database management system 130 and the second database management system 140 may store other data instead of or in addition to financial account data. By way of example, as noted above, in some implementations, the first database management system 130 and the second database management system 140 may manage computing resources such as memory and/or processor cycles which may be used by the transferor device 110. The records may, for example, associate a particular entity with particular resources. For example, the records may entitle a particular entity exclusive or shared use of a computing resource. The database management systems 130, 140 may communicate with one another in order to send and receive request-to-transfer messages that transfer use of a resource from a record maintained by the second database management system 140 to a record maintained by the first database management system 130.

In another example, the database management systems 130, 140 may act as cloud-based storage and may store files, such as documents for various entities. The second database management system 140 may, in accordance with instructions received from an entity associated with a document, transfer that document to another entity having a record at the first database management system 130. By way of example, the document may be a media file, such as an electronic book, video file or audio file, having digital rights management (DRM) which only permits the document to be transferred if exclusive use of the document is transferred (i.e., if the transfer is performed such that the transferor is no longer able to use the document after the transfer). The database management systems 130, 140 may communicate with one another in order to transfer the document in accordance with instructions received from the transferor device 110.

The transferor device 110 and the transferee device 108 may each take a variety of forms such as a smartphone, a tablet computer, a wearable computer such as a head-mounted display or smartwatch, a laptop or desktop computer, or a computing device of another type. The first database management system 130 and/or the second database management system 140 may be referred to as first and second computing devices and/or first and second computing systems respectively and may also be referred to as first and second servers, respectively. The transferor device 110 and the transferee device 108 may each be referred to as one or more of a client device, an electronic device, a computing device and a computing system.

The network 150 is a computer network. In some embodiments, the network 150 may be an internetwork such as may be formed of one or more interconnected computer networks. For example, the network 150 may be or may include an Ethernet network, an asynchronous transfer mode (ATM) network, a wireless network, a telecommunications network, or the like.

The first database management system 130 may be configured to communicate with other servers, such as the second database management system 140 using one or more communication protocols, which may also be referred to as transfer protocols or transfer rails.

In at least some embodiments, a transfer rail server 160 may be configured to facilitate a transfer from a first data record to a second data record according to a first transfer protocol. The first data record may be a data record maintained by the second database management system 140 and the second data record may be a data record maintained by a server associated with a different system operator than the second database management system 140 (e.g., such as the first database management system 130). The transfer rail server 160 may operate as an intermediary between the first database management system 130 and the second database management system 140.

One or more of the transfer protocols may not require the use of a transfer rail server. For example, one or more of the transfer protocols may operate through the exchange of messages directly between the first database management system 130 and the second database management system 140. Such messages may be exchanged through the network 150.

The transferor device 110, the transferee device 108, the first database management system 130, the second database management system 140, and the transfer rail server 160 may be in geographically disparate locations. Put differently, the transferor device 110, the transferee device 108, the first database management system 130, the second database management system 140, and the transfer rail server 160 may be remote from one another.

The first database management system 130 may be configured to operate as a first database management system by updating, creating and deleting records in an associated database and the second database management system 140 may be configured to operate as a second database management system by updating, creating and deleting records in an associated database. A database management system may be configured to send and receive a request-to-transfer which may also be referred to herein as a request-to-transfer message. A request-to-transfer may be a specially formatted message that is sent from a first database management system 130 to a second database management system 140. The request-to-transfer may be sent from the first database management system 130 to the second database management system 140 over a transfer rail that is used for facilitating transfers between databases associated with different database management systems. For example, the first database management system 130 may be associated with a first database 180 and the second database management system 140 may be associated with a second database 120.

The first and second databases 180, 120 may store account data. That is, the first and second databases 180, 120 may store data that is associated with various accounts. In at least some implementations, each record/logical storage area in the first and second databases 180, 120 may be associated with a particular one of these accounts.

The first database management system 130 and the second database management system 140 are computing systems and may be referred to, for example, as a first computing system and a second computing system respectively.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components.

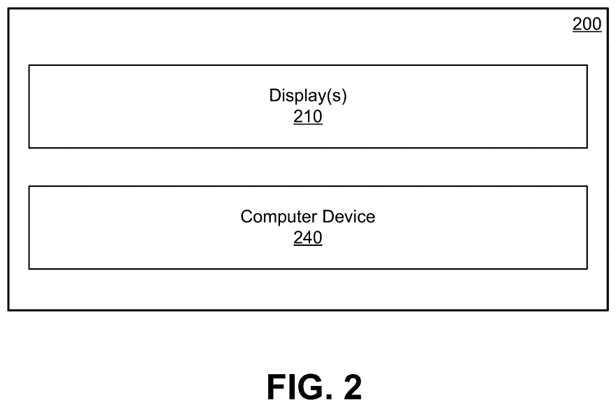

FIG. 2 is a simplified schematic diagram showing components of an exemplary computing device 200. The computing device 200 may include modules including, as illustrated, for example, one or more displays 210 and a computer device 240. The computing device 200 may be or include one of the systems of FIG. 1. For example, in some implementations, the computing device 200 may operate as the transferor device 110. Another computing device 200 may operate as the transferee device 108. Another computing device 200 may operate as the first database management system 130. Another computing device 200 may operate as the second database management system 140.

The one or more displays 210 may be or include a display module. The one or more displays 210 are used to display screens of a graphical user interface that may be used, for example, to communicate with the first database management system 130 (FIG. 1) and/or the second database management system 140 (FIG. 1). The one or more displays 210 may be internal displays of the computing device 200 (e.g., disposed within a body of the computing device).

The computer device 240 is in communication with the one or more displays 210. The computer device 240 may be or may include a processor which is coupled to the one or more displays 210.

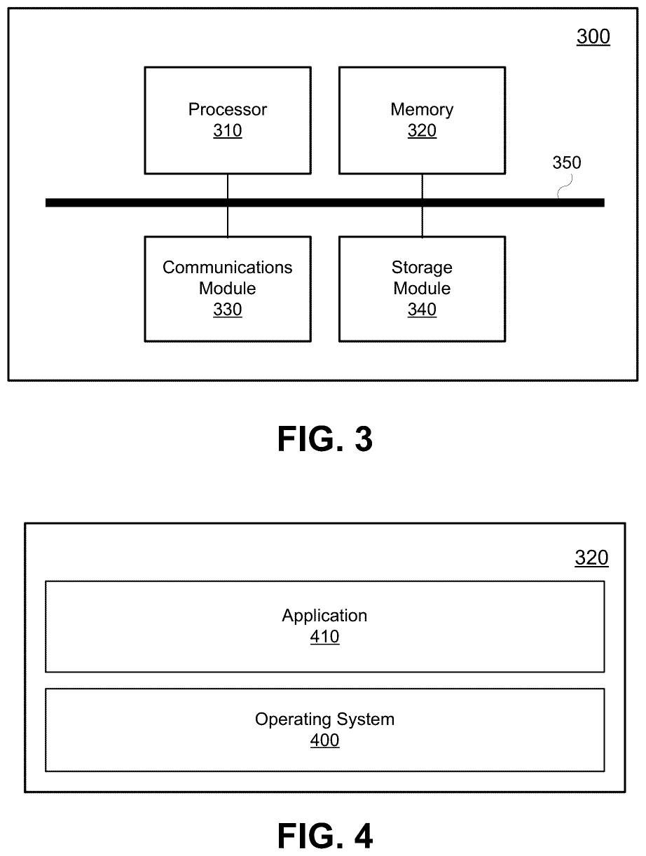

Referring now to FIG. 3, a high-level operation diagram of an example computer device 300 is shown. In some embodiments, the computer device 300 may be exemplary of the computer device 240 (FIG. 2), the first database management system 130, the transferor device 110, the transferee device 108 and/or the second database management system 140.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive, or the like. Read-only memory and persistent storage are a non-transitory computer-readable storage medium. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Where the example computer device 300 functions as the first database management system 130 of FIG. 1, the storage module 340 may allow the example computing device 300 to access the secure data in the first database 180. Likewise, where the example computer device 300 functions as the second database management system 140 of FIG. 1, the storage module 340 may allow the example computing device 300 to access the secure data in the second database 120.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2), the transferor device 110, the transferee device 108, the first database management system 130, and/or the second database management system 140.

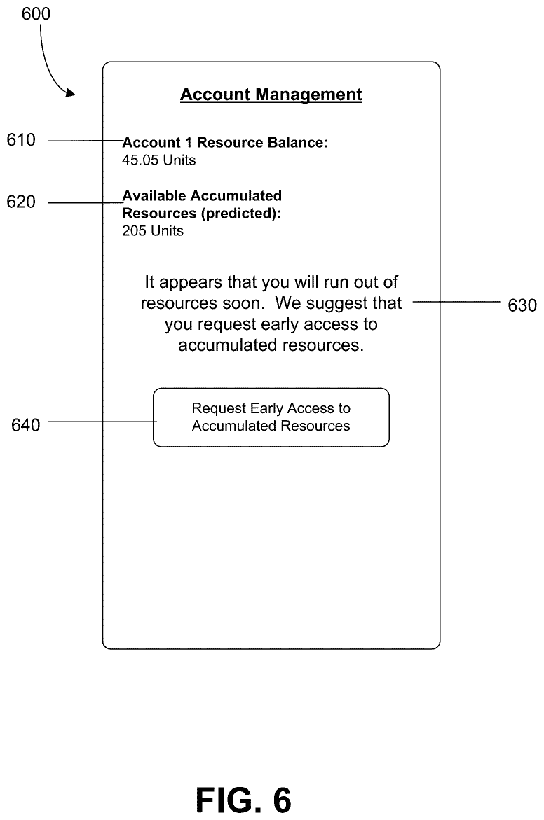

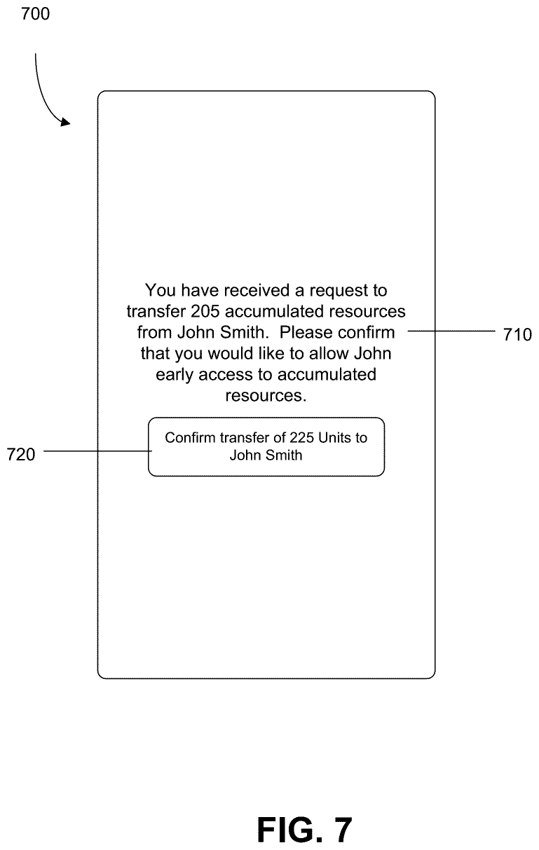

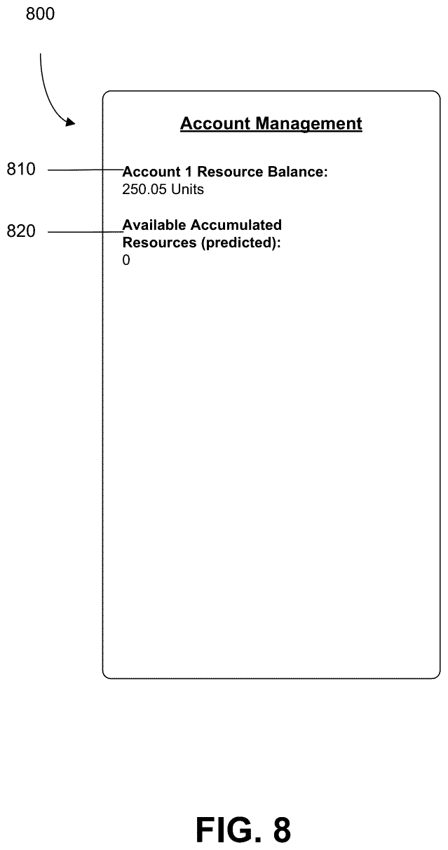

While a single application 410 is illustrated in FIG. 3, in operation the memory 320 may include more than one application 410 and different applications 410 may perform different operations. For example, in at least some embodiments in which the computer device 300 is functioning as the transferor device 110 or the transferee device 108, the applications 410 may include a transfer initiation application. The transfer initiation application may be configured for secure communications with the first database management system 130 and may provide various functions such as, for example, the ability to display data in a record in the first database 180. In some implementations, the transfer initiation application may be a banking application which may, for example, be configured to display a quantum of value in one or more data records (e.g., display balances), configure or request that operations such as transfers of value (e.g., bill payments, email money transfers and other transfers) be performed, and perform other account management functions. The transfer initiation application may, in at least some implementations, configure the transferee device to display account management interfaces 600, 800 of the type described above with reference to FIGS. 6 and 8. Similarly, a transfer initiation application on the transferor device 110 may cause the transferor device to display a notification 700 of the type described with reference to FIG. 7.

By way of further example, in at least some embodiments in which the computer device 300 functions as the transferor device 110 or the transferee device 108, the applications 410 may include a web browser, which may also be referred to as an Internet browser. In at least some such embodiments, the first database management system 130 may be or include a web server that may serve one or more of the interfaces described herein. The web server may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g., display balances), configure or request that operations such as transfers of value (e.g., bill payments and other transfers) be performed, and other account management functions. Accordingly, in at least some implementations, the account management interface 600, 800 of FIGS. 6 and/or 8 may be displayed in a web browser.

The first database management system 130 and/or the second database management system 140 may be configured to receive and complete request-to-transfer messages. A request-to-transfer is a message that is sent on behalf of a recipient to initiate a transfer from a sender, i.e., a transferor, to the recipient. That is, the request-to-transfer is sent, on behalf of the recipient, from the database management system associated with the recipient (e.g. the first database management system 130) to the database management system associated with the sender (e.g. the second database management system 140). The request-to-transfer requests a transfer from a record in the database that is associated with the sender (e.g., in the second database 120) to a record in the database that is associated with the recipient (e.g., in the first database 180). The request-to-transfer includes one or more identifiers that identify the record associated with the sender and/or the record associated with the recipient. The identifier(s) may be or include an account number. The request-to-transfer may also include one or more identifiers that identify the second database management system 140 associated with the sender and/or that identify the first database management system 130 associated with the recipient. Such identifiers may be or include one or more of: a transit number and an institution number.

The request-to-transfer is a transfer initiation message. That is, the request-to-transfer is an initial message that may be used to cause a transfer to occur. Since the request-to-transfer is initiated by a recipient rather than a sender, the request-to-transfer may be considered a pull-style transfer, which may be contrasted with typical push-style transfers. In at least some implementations, the request-to-transfer may be formatted as an ISO20022 message.

The request-to-transfer message is specially formatted to include parameters of a transfer that is requested to be made from a sender. The parameters may be included as metadata in the transfer message. Where the request-to-transfer is an ISO20022 message, the parameters may be included in an ISO20022 format. The parameters may include resource definition data. The resource definition data defines what is requested to be transferred. By way of example, the resource definition data may define a resource that is stored in or otherwise associated with a record associated with the sender. The resource may be, for example, a computing resource. In another implementation, the resource may be data. In some implementations, the resource may represent an amount of value, such as a quantity of a currency.

The parameters that are included in the request-to-transfer may include data of another type. For example, in some implementations, the parameters may be or include transfer scheduling data. The transfer scheduling data may represent a time when the requested transfer is to be made. This time may be, for example, a due date or deadline. The due date or deadline represents a latest time at which the transfer is to be made.

The request-to-transfer message may, in some implementations, be or represent a request for payment. Such a message may be referred to as a request for payment (RFP) message or a request to pay (RTP) message. In such implementations, the transfer rail may be a payment rail such as a real time payment rail and the database management systems may be a financial institution system. In at least some such implementations, the records may represent bank accounts and a transfer may be a request-to-transfer value from a sender bank account to the recipient bank account. The request-to-transfer message may be sent from a first financial institution system, which is associated with a first financial institution, to a second financial institution system, which is associated with a second financial institution.

The request-to-transfer message is a special transfer message which is not formatted as an email or short message service (SMS) message. Rather, it is a computer-to-computer message that is formatted to be specially processed by the database management system that receives it. In at least some implementations, the computer-to-computer message may be formatted according to the ISO20022 standard. For example, the second database management system 140 that receives the request-to-transfer message may be configured to execute a process for obtaining authorization to complete a transfer in response to receiving the request-to-transfer. More particularly, the database management systems may be configured to only permit authorized transfers. For example, in one implementation, the second database 120 stores account data for a plurality of accounts and a database management system will only allow a transfer out of an account if the transfer is authorized by an authorization entity for that account, such as an accountholder. Authorization may, for example, require authenticated approval using a credential such as one or more of a username, password, biometric authentication data or other credential.

In one implementation, in response to receiving the request-to-transfer message, a database management system (such as the second database management system 140) may identify an affected account using an identifier defined by the transfer message. Then, this database management system may send an electronic notification to a transferor device 110 associated with the identified account. This notification may be provided as an in-application notification or operating system level notification. The notification may include a selectable option to authorize the transfer.

The notification may allow the transfer to be made without requiring input of one or more parameters that are typically required when a transfer is initiated by the sender rather than the recipient. By way of example, one or more parameters that are included in the request-to-transfer may be used to pre-stage or pre-populate parameters of the transfer so that the sender does not have to input such parameters. In some implementations, the resource definition data included in the request-to-transfer may be used to allow the transfer to be made without having the sender define what is to be transferred. For example, where the transfer is a transfer of a computing resource or data, the sender may perform the transfer without having to input any information defining the computing resource or data involved. Or, where the transfer is a transfer of an amount of value, the amount of value defined in the request for transfer message may be used so that the sender does not have to define the amount of value.

In some implementations, transfer scheduling data included in the request-to-transfer message may be used to schedule the transfer without requiring the sender to define such a schedule. For example, where the transfer scheduling data is a due date or deadline, the database management system associated with the sender may automatically define a time for a transfer based on the transfer scheduling data without requiring the sender to input such a time.

In this way, the sender may cause a second database management system 140 that is associated with the sender's record in a second database 120 to perform the transfer without having to input any parameters for the transfer. The time and/or amount of the transfer may be extracted directly from the request-to-transfer message. The sender may only need to input an indication of consent to initiate the transfer when the sender has authenticated to the second database management system 140 and the transfer may then be performed.

In at least some implementations, the request-to-transfer may be configured to be automatically processed by the second database management system such that a transfer may be made automatically without user input of an indication of consent for the particular transfer as long as the requested transfer satisfies defined conditions. For example, the defined conditions may be based on an amount of the requested transfer and/or a typical scheduled transfer amount for transfers made as regularly scheduled to the transferee. The automatic processing may be based on other criteria apart from those specifically listed above.

In some implementations, the database management system (such as the second database management system 140) may process the request-to-transfer by using the parameters defined in the request-to-transfer as default parameters for a pre-staged transfer which can be overridden through input of alternative parameters by the sender.

As will be described in greater detail below, a request-to-transfer may be used to allow for early access to resources without having to configure legacy systems for interoperability with an early access system. The techniques described herein may greatly simplify computing requirements needed to implement early access services and may allow early access services to be used with any employer, irrespective of their payment processing and time tracking computing infrastructure.

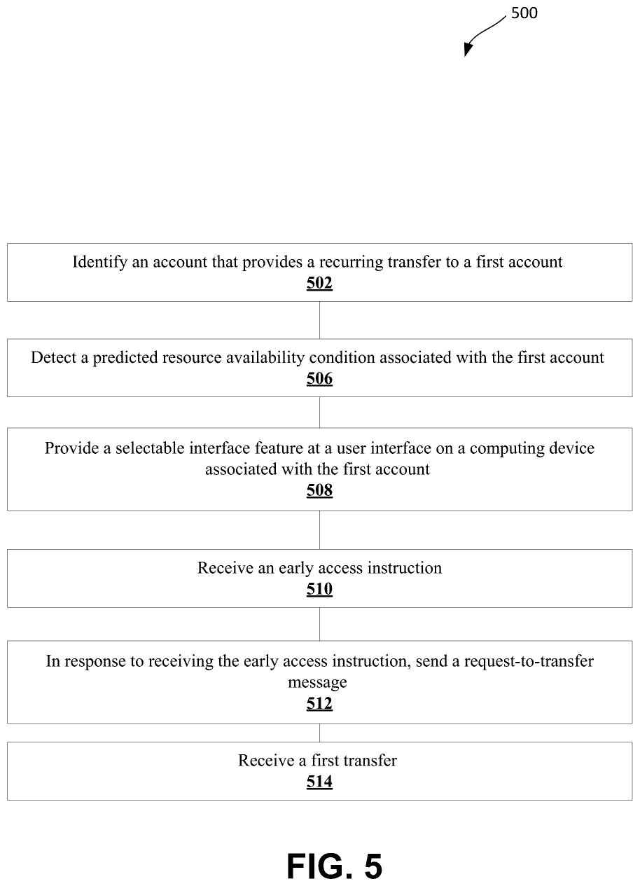

Reference is now made to FIG. 5, which shows, in flowchart form, an example method 500 of providing early access to an accumulated resource using a request-to-transfer. The method 500 may be implemented by a computing system such as the first database management system 130 of FIG. 1. For example, a software module may be configured to cause the first database management system 130 of FIG. 1 to implement the method 500. The method 500 may be performed, for example, by the processor 310 (FIG. 3) of a computing device 300 executing software comprising instructions such as may be stored in the memory 320 of the computing device 300. More particularly, processor-executable instructions may, when executed, configure a processor 310 of a computing system such as the first database management system 130 to perform all or parts of the method 500 or a portion thereof.

In performing the method 500, the first database management system 130 may cooperate with other systems and devices such as, for example, a transferee device 108 (FIG. 1) and/or a second database management system 140. Each of these devices may be configured with processor-executable instructions which cause such devices to perform methods which cooperate with the method 500. Accordingly, operations that are referred to below as being performed by the transferee device 108 may be included in a method which a processor of the transferee device 108 may perform. Similarly, operations that are referred to below as being performed by the second database management system 140 may be included in a method which a processor of the second database management system 140 may perform. Further, in performing such a method, the second database management system 140 may cooperate with the transferor device 110 which may perform another method. That method may include any operations described herein as being performed by the transferor device 110. Further, it is contemplated that a method may be performed by a system that includes two or more of the first database management system 130, the second database management system 140, the transferor device 110 and the transferee device 108 such that the method may include operations performed by multiple devices.

At an operation 502 of the method 500, the computing system performing the method may identify an account that provides a recurring transfer to a first account. The account that provides the recurring transfer may be referred to as a second account. A computing system such as the first database management system 130 may identify the second account by identifying an account from which a recurring transfer into the first account has been previously made. In order to identify the second account, the first account may access account data such as, for example, a transfer history. The account data may be stored in the first database 180. Specifically, the computing system may identify the second account based on past incoming transfer data.

An external resource system associated with the second account may be configured to periodically transfer resources to the first account. The periodic transfer of resources may occur weekly, bi-weekly, monthly, or on some other schedule in some implementations. That is, the resources in the user account may be replenished or supplemented from the external resource system in regular or somewhat regular intervals. As an example, in the case of a mobile communications account with fixed data usage caps and extra fees for overages, the resources may include data usage and the replenishment may be re-setting of the data usage meter each billing cycle, which equates to allocating the full data usage cap to the account each billing cycle. In another example, the user account may include a bank account and the external resource system may include a payroll system that automatically deposits wages to the bank account in accordance with a payroll schedule. The payroll schedule may be weekly, bi-weekly, monthly, or on some other frequency. The quantity of funds deposited may be fixed in the case of a salaried employee, but subject to various deductions or bonuses or other credits or debits administered by the payroll system. In the case of an hourly employee, the wages may vary from pay period to pay period dependent on the number and type of hours recorded in the payroll system for an employee associated with the user account.

The computing system performing the method 500 may identify the second account by identifying an account that has provided periodic transfers of resources to the first account in the past. This may be done in various ways including, for example, by matching or fuzzy matching past transfers from a particular originating account to the first account.

The second account may be identified using a unique account identifier associated with the second account. The account identifier may be or include one or more of a namespace identifier and one or more account numbers that are unique within the namespace defined by the namespace identifier. By way of example, the namespace identifier may be or include a system or entity identifier. By way of example, the namespace identifier may be or include one or both of a transit number and an institution number.

Other information may be identified at the operation 502 from the transfer history instead of or in addition to a second account identifier. For example, in some implementations, a standard, typical, or recent transfer amount may be identified. In some implementations, a last date of a recurring transfer from the second account to the first account may be identified. In some implementations, a period between recurring transfers from the second account may be determined. The period may be an average period, a most-recent period and/or a period that matches one or more period templates. The period templates may be, for example, weekly, bi-weekly, monthly, yearly, daily, etc. In some implementations, the period templates may include templates that exclude certain days such as, for example, weekends. For example, it may be that transfers according to some period templates are only to occur on weekdays.

At an operation 506, the computing system performing the method 500 may detect a predicted resource availability condition associated with the first account. A predicted resource availability condition associated with the first account may be detected based on the transfer history for the first account. The transfer history may be stored in the first database 180. The predicted resource availability condition may be detected by determining that an accumulated resource amount associated with a resource transfer expected to be scheduled to occur at a future time is expected to be available for immediate access. Put differently, when the computing system determines that an earned resource is available at a second account, it may be determined to have detected the predicted resource availability. An earned resource may be a resource that has accumulated since a last transfer from the second account to the first account and that has not yet been transferred.

The resource may be considered, by the computing system, to accumulate linearly over a time period in at least some implementations. For example, it may be that a transfer amount (such as a standard, typical or recent transfer amount) that is expected to be made on the regularly-scheduled transfer date (i.e., after expiration of the period) accrues at a linear daily rate. For example, for a weekly transfer of 700 units, it may be assumed that 100 units have accumulated after each day. At the operation 506, the computing system may determine the amount of resources that have accumulated since the last transfer date.

Accordingly, detecting a predicted resource availability condition associated with a first account may include determining the accumulated resource amount based on one or more of: a last date for a recurring transfer from the second account to the first account, an amount of one or more past transfers from the second account to the first account, and a determined period between the recurring transfers. In at least some implementations, the amount of accumulated resources may be determined based on a number of elapsed resource accumulation days since a last transfer. A resource accumulation days may include days of a first type (e.g., weekdays) and exclude days of a second type (e.g., days on weekends). Accordingly, in determining the accumulated resource amount, the computing system may determine a portion of the resource transfer expected to be scheduled to occur at a future time (i.e., at the next scheduled transfer date) that is attributable to current progress within the determined period (i.e., with the period between the last transfer from the second account and a next expected transfer date from the second account).

In some implementations, when determining the accumulated resource amount, a calculated amount may be reduced using a modifier. The modifier may be a subtraction modifier and/or a division modifier. In some implementations, the modifier may be a percentage reduction. The modifier may be applied to account for any possible errors in the prediction of the accumulated resource amount.

The accumulated resource amount may be determined taking into account any prior transfers from the second account to the first account that were received after a last regularly scheduled transfer that were made in response to a request-to-transfer message of the type described below with reference to the operation 512 of the method 500 of FIG. 5. That is, the computing system takes into account whether early access to accumulated resources associated with a next regularly-scheduled transfer has already been provided.

Referring still to FIG. 5, the computing system performing the method 500 may, at an operation 508, in response to detecting the predicted resource availability condition, provide a selectable interface feature at a user interface on a computing device associated with the first account. By way of example, the selectable interface feature may be provided on the transferee device 108. The selectable interface feature may be configured for inputting an early access instruction to request immediate release of at least a portion of the accumulated resource amount.

The selectable interface feature may be provided in one or more of a notification, an interface and a message. An example interface 600 which includes a selectable interface feature 640 is illustrated in FIG. 6. The selectable interface feature 640 may also be referred to as a selectable interface element. In the illustrated example, the interface 600 is an account management interface. The account management interface includes a statement of resources for the first account such as, for example, a resource balance 610. The account management interface may also include an indication 620 of the accumulated resource amount. The account management interface may also include an indication 630 of a recommended action with respect to the accumulated resources.

The selectable interface feature 640 may be displayed when it is determined that accumulated resources are available. If it is determined that no accumulated resources are available, then the display of the selectable interface feature 640 may be suppressed. In some implementations, one or more other preconditions must be determined to have been satisfied for the selectable interface feature 640 to be displayed. For example, it may be that the selectable interface feature 640 is only displayed when a particular screen of a user interface is accessed; for example, the account management interface 600 of FIG. 6. By way of further example, it may be that the selectable interface feature 640 is only displayed when the resources in the first account satisfy certain criteria. For example, the selectable interface feature 640 may be displayed when a level of resources in the first account falls below a threshold but such display is suppressed when the level of resources in the first account is above the threshold. By way of yet a further example, it may be that the selectable interface feature 640 is only displayed when the accumulated resources are sufficiently high to cause such display. Sufficiency may be determined based on a threshold. By way of example, it may be that the selectable interface feature 640 is displayed when it is determined that at least a threshold amount of resources have accumulated but it may not be displayed when the threshold amount of resources have not accumulated.

The selectable interface feature is, in the example, a button. The selectable interface feature may take other forms. For example, the selectable interface feature may be a link, checkbox, radio button, etc. In some implementations, the selectable interface feature may be an icon that may be dragged to another location on a display screen (such as to an indicator of a first account and/or a first account resource balance) to input the early access instruction to request immediate release of at least a portion of the accumulated resource amount.

In some implementations, the selectable interface feature 640 may include an option to define an amount of resources to be accessed. In at least some implementations, the selectable interface feature 640 may be configured to cap the amount of resources that may be indicated using the selectable interface feature so that no more than the accumulated amount of resources may be input. The selectable interface feature 640 may, for example, be or include a slider with a maximum range that is based on the determined accumulated amount of resources.

Since the interface 600 of FIG. 6 may be called for display on the transferee device 108 at various times, to ensure accuracy of data and to prevent lags in the display of the interface 600, the accumulated transfer amount may be determined regularly or semi-regularly. For example, it may be that the determination is made daily and/or on weekdays.

Referring again to FIG. 5, the method 500 may continue at an operation 510. At the operation 510, the computing system performing the method 500 may receive the early access instruction. The early access instruction may be received via a communications module. The early access instruction may be received when the selectable interface feature 640 is selected or otherwise activated using an input device associated with the transferee device 108 upon which the selectable interface feature 640 is output. The input device may be of various types including, for example, a touchscreen, a keyboard, a scroll wheel, a keypad, a mouse, a physical button, a camera, a microphone, etc. The early access instruction may be received as an electronic message. The early access instruction may be a device-to-device message.

The computing system performing the method 500 may, at an operation 512, in response to receiving the early access instruction, send a request-to-transfer message to the second account. That is, the computing system may send the request-to-transfer message to an account identified as being associated with the resource transfer that is expected to be scheduled to occur. Put differently, the computing system may send the request-to-transfer message to an account having an accumulated resource amount for a transfer that is expected to be scheduled to occur at a future time.

A request-to-transfer may be a message of the type described above. For example, a request-to-transfer may be a specially-formatted message that is sent on behalf of a recipient to initiate a transfer from a sender, i.e., a transferor, to the recipient. That is, the request-to-transfer is sent, on behalf of the recipient, from the first database management system 130 to the second database management system 140. The request-to-transfer may be sent to a second database management system 140 that is identified as being associated with the second account (which may be the account identified at an operation 502). For example, the namespace identifier may be used to identify the database management system to which the request-to-transfer is to be sent. The request-to-transfer includes one or more identifiers that identify the record associated with the sender and/or the record associated with the recipient. The identifier(s) may be or include an account number. The request-to-transfer may also include one or more identifiers that identify the second database management system 140 associated with the sender and/or that identify the first database management system 130 associated with the recipient. Such identifiers may be or include one or more of: a transit number and an institution number. The identifiers may be or include identifiers described above with reference to the operation 502.

The request-to-transfer is a transfer initiation message. That is, the request-to-transfer is an initial message that may be used to cause a transfer to occur. In at least some implementations, the request-to-transfer may be formatted as an ISO20022 message.

The request-to-transfer message is specially formatted to include parameters of a transfer that is requested to be made from a sender. The parameters may be included as metadata in the transfer message. Where the request-to-transfer is an ISO20022 message, the parameters may be included in an ISO20022 format. The parameters may include resource definition data. The resource definition data defines what is requested to be transferred. By way of example, the resource definition data may define a resource that is stored in or otherwise associated with a record associated with the sender. The resource may be, for example, a computing resource. In another implementation, the resource may be data. In some implementations, the resource may represent an amount of value, such as a quantity of a currency.

The request-to-transfer message may, in some implementations, be or represent a request for payment. Such a message may be referred to as a request for payment (RFP) message or a request to pay (RTP) message. In such implementations, the request-to-transfer may be sent over the transfer rail that may be a payment rail such as a real time payment rail and the database management systems may be a financial institution system. In at least some such implementations, the records may represent bank accounts and a transfer may be a request-to-transfer value from a sender bank account to the recipient bank account. The request-to-transfer message may be sent from a first financial institution system, which is associated with a first financial institution, to a second financial institution system, which is associated with a second financial institution.

The request-to-transfer message is a special transfer message which is not formatted as an email or short message service (SMS) message. Rather, it is a computer-to-computer message that is formatted to be specially processed by the database management system that receives it. In at least some implementations, the computer-to-computer message may be formatted according to the ISO20022 standard.

The request-to-transfer message specifies an amount of resources that are requested to be transferred. The request-to-transfer may only request a transfer of an amount of resources that is less than or equal to the accumulated resource amount. The amount may be the amount defined using the selectable interface feature 640 (FIG. 6) and/or input at the interface 600 (FIG. 6).

In at least some implementations, the request-to-transfer message includes a flag or other indicator which indicates that the message requests an advance on a scheduled transfer. This flag or other indicator may be set or configured to indicate, to the second database management system 140 that the request-to-transfer requests an advance on a scheduled transfer. This may allow the second database management system 140 to process the request-to-transfer message differently from other request-to-transfer messages that are not similarly configured.

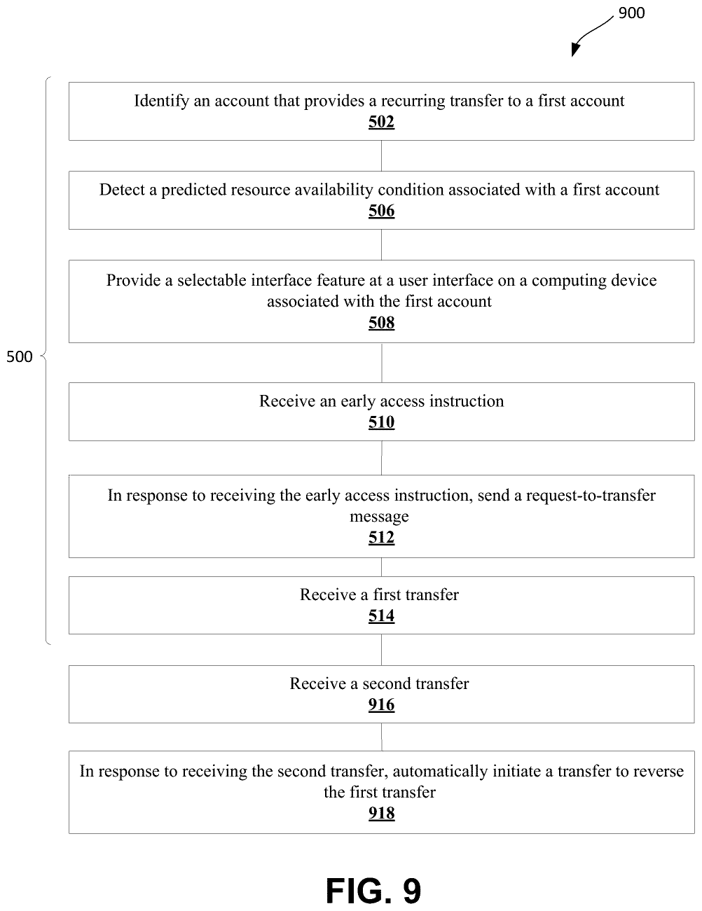

In some implementations, the message may include a signature generated from a private key applied to particular data. The private key may be associated with the first database management system 130. This signature may be verified by the first database management system 130 to ensure that the data was, in fact, signed by the first database management system 130. The particular data may be a refund indicator, for example. The refund indicator may indicate that the first database management system 130 certifies that a reversal transfer will be automatically processed for any advanced resources after a regularly scheduled transfer is later made. This indicates to the second database management system 140 that the first database management system 130 is configured to not permit a user associated with the first account to prevent such a reversal transfer. Reversal transfers will be discussed in greater detail below with reference to the method 900 of FIG. 9.

Accordingly, the request-to-transfer message may be sent from a first financial institution system to a second financial institution system. The request-to-transfer message may be a pre-staged transfer message that allows a transfer to be sent without input of a transfer amount.

The second database management system 140 that receives the request-to-transfer message may be configured to execute a process for obtaining authorization to complete a transfer in response to receiving the request-to-transfer message. More particularly, the database management systems may be configured to only permit authorized transfers. For example, in one implementation, the second database 120 stores account data for a plurality of accounts and a database management system will only allow a transfer out of an account if the transfer is authorized by an authorization entity for that account, such as an accountholder. Authorization may, for example, require authenticated approval using a credential such as one or more of a username, password, biometric authentication data or other credential.

In one implementation, in response to receiving the request-to-transfer message, the second database management system 140 may identify an affected account using an identifier defined by the transfer message. Then, this database management system may send an electronic notification to a transferor device 110 associated with the identified account. This notification may be provided as an in-application notification or operating system level notification. The notification may include a selectable option to authorize the transfer.

An example notification 700 is illustrated in FIG. 7. The example notification includes a message 710 which indicates that the request-to-transfer has been received. The message 710 may indicate an amount of resources requested to be transferred. The message 710 may indicate a recipient of the transfer. For example, a recipient identifier may be included in the message 710.

The example notification 700 also includes a selectable option 720 to provide an indication of consent to the second database management system 140. The indication of consent provides the second database management system 140 with authorization to cause the second database management system 140 to initiate a transfer in response to the request-to-transfer message.

The notification 700 may allow the transfer to be made without requiring input of one or more parameters that are typically required when a transfer is initiated by the sender rather than the recipient. By way of example, one or more parameters that are included in the request-to-transfer may be used to pre-stage or pre-populate parameters of the transfer so that the sender does not have to input such parameters. In some implementations, the resource definition data included in the request-to-transfer may be used to allow the transfer to be made without having the sender define what is to be transferred. For example, where the transfer is a transfer of a computing resource or data, the sender may perform the transfer without having to input any information defining the computing resource or data involved. Or, where the transfer is a transfer of an amount of value, the amount of value defined in the request for transfer message may be used so that the sender does not have to define the amount of value.

In some implementations, such as implementations which allow for inclusion of a flag or other indicator which indicates that the message requests an advance on a scheduled transfer, the second database management system 140 may determine whether the request-to-transfer message includes a flag or indicator set to indicate that the message requests an advance on a scheduled transfer. If the flag or indicator is set to indicate that the message requests an advance on a scheduled transfer, the second database management system 140 may process the request-to-transfer message differently than if the flag or indicator is not set to indicate that the message requests an advance on a scheduled transfer. For example, when the flag or indicator is set to indicate that the message requests an advance, then the notification 700 may be modified to indicate that the request is for an advance.

In some implementations, the request-to-transfer message may include a signature generated from a private key applied to particular data and, upon receiving the request-to-transfer message, the second database management system may verify the signature using a public key corresponding to the private key. If the signature does not successfully verify, then the request-to-transfer message may be rejected.

Further, in some implementations, it may be that the request-to-transfer message includes a refund indicator. If the second database management system 140 determines that the request-to-transfer message includes a refund indicator, it may process the request-to-transfer message differently than if the request-to-transfer message does not include the refund indicator. For example, the notification 700 may be updated or modified based on this determination. For example, the notification may indicate that the transfer will be automatically reversable after a scheduled transfer is made.

The notification of FIG. 7 may be modified to be different than the notification 700 of FIG. 7. For example, the notification may include a selectable option to deny the transfer. The selectable option may be used to send a message to the second database management system 140 to deny the transfer. This option may cause the second database management system 140 to send a denial message to the first database management system 130.

In some implementations, the request-to-transfer message may include an identifier for the first account to allow for verification of the request-to-transfer message. In at least some implementations, in response to receiving the request-to-transfer message, the second database management system 140 may verify that the request-to-transfer message has been received from a recipient of recurring transfers. This may involve comparing an account identifier of the first account to accounts for recurring transfers made from the second account in the past. Additionally or alternatively, the verification may involve comparing an entity identifier associated with the first account (such as a name) to an entity identifier in a list of entities. The list of entities may be, for example, an employee list for the transferor.

If the second database management system 140 receives, from the transferor device, an indication of authorization to complete the transfer, then the second database management system may cause a first transfer to be performed. The first transfer is performed by updating a ledger associated with the second account to show a negative modification to a resource balance and by sending a message to the first database management system 130 to cause a resource balance in the first account to be adjusted by a corresponding and/or related amount.

Referring to FIG. 5, at an operation 514, the method 500 may include receiving, at the first account and from the second account, a first transfer in the requested amount. At the operation 514, the first database management system 130 may receive a message from the second database management system 140 and may, in response, cause the resource balance in the first account to be adjusted to account for the first transfer.

In at least some implementations, when the resource balance has been adjusted, a notification may be provided to the transferee device 108. The notification may take various forms. One such form is illustrated in FIG. 7 where the notification is included in an account management interface 800 which is similar to the account management interface 600 of FIG. 6. The account management interface 800 of FIG. 8 indicates a resource balance 810 which has been updated from the resource balance 610 displayed before the first transfer to indicate the effect of the first transfer. The account management interface 800 may also include an indication 820 of a new accumulated resource amount. This too has been updated from the indication 620 of the accumulated resource amount in FIG. 6 to account for the first transfer. In the illustrated example, the account management interface 800 excludes the selectable interface feature 640 of FIG. 6 since the first account management system 130 has suppressed such a feature due to the unavailability of accumulated resources for transfer.

In some instances and for some applications, the transfer of accumulated resources made by way of the first transfer ahead of a scheduled transfer may complicate the scheduled transfer. For example, the scheduled transfer may be already configured and adjusting the scheduled transfer may cause a computing or other resource burden. Further, in the context of payroll systems, handling remittances such as payroll taxes may be difficult due to the transfer of the accumulated resources. As will be described in greater detail below, to avoid such complications, the method 500 of FIG. 5 may be adapted to include operations for effecting an automatic reversal of the first transfer after a regularly-scheduled transfer is received.

Reference is now made to FIG. 9, which shows, in flowchart form, a further example method 900 of providing early access to an accumulated resource using a request-to-transfer. The method 900 may be implemented by a computing system such as the first database management system 130 of FIG. 1. For example, a software module may be configured to cause the first database management system 130 of FIG. 1 to implement the method 900. The method 900 may be performed, for example, by the processor 310 (FIG. 3) of a computing device 300 executing software comprising instructions such as may be stored in the memory 320 of the computing device 300. More particularly, processor-executable instructions may, when executed, configure a processor 310 of a computing system such as the first database management system 130 to perform all or parts of the method 900 or a portion thereof.

In performing the method 900, the first database management system 130 may cooperate with other systems and devices such as, for example, a transferee device 108 (FIG. 1) and/or a second database management system 140. Each of these devices may be configured with processor-executable instructions which cause such devices to perform methods which cooperate with the method 900. Accordingly, operations that are referred to below as being performed by the transferee device 108 may be included in a method which a processor of the transferee device 108 may perform. Similarly, operations that are referred to below as being performed by the second database management system 140 may be included in a method which a processor of the second database management system 140 may perform. Further, in performing such a method, the second database management system 140 may cooperate with the transferor device 110 which may perform another method. That method may include any operations described herein as being performed by the transferor device 110. Further, it is contemplated that a method may be performed by a system that includes two or more of the first database management system 130, the second database management system 140, the transferor device 110 and the transferee device 108 such that the method may include operations performed by multiple devices.

The method 900 may include the method 500 or portions thereof. For example, the method 500 may include the operations 502, 506, 508, 510, 512 and 514 or a portion of such operations. The description of such operations will not be repeated at length.

The method 900 also includes, at an operation 916, receiving, at the first account and from the second account, a second transfer. The second transfer is a transfer for a further amount. The second transfer may be a regularly-scheduled transfer from the second account to the first account. The second transfer may represent a regularly scheduled replenishment to an account such as a monthly data allocation, a monthly server time allocation, a regular income deposit (e.g. payroll payment).

Next, at an operation 918, in response to receiving the second transfer, the first database management system 130 may automatically initiate a transfer to reverse the first transfer. This transfer may be referred to as a third transfer and/or a reversal transfer. This transfer to reverse the first transfer is made without any interaction from any operator and without permitting an account-holder for the first account to prevent the transfer to reverse the first transfer. That is, the third transfer is initiated automatically by the first database management system 130 when it detects the regularly scheduled transfer from the second account to the first account.

In at least some implementations, the transfer at the operation 918 may be performed in real time following receipt of the second transfer at the operation 916. In this way, any over-transfer of resources caused by the combination of the first and second transfers may be remedied immediately. Real time is intended to refer to a time period of less than 30 seconds.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computing system comprising:
a communications module;
a processor coupled to the communications module; and
a memory coupled to the processor storing instructions that, when executed by the computing system, cause the computing system to:
detect a predicted resource availability condition associated with a first account by determining, based on a transfer history, that an accumulated resource amount associated with a resource transfer expected to be scheduled to occur at a future time is expected to be available for immediate access;
in response to detecting the predicted resource availability condition, provide a selectable interface feature at a user interface on a computing device associated with the first account, the selectable interface feature configured for inputting an early access instruction to request immediate release of at least a portion of the accumulated resource amount;
receive the early access instruction; and
in response to receiving the early access instruction, send a request-to-transfer message to a second account, the second account identified as being associated with the resource transfer expected to be scheduled to occur, the request-to-transfer message requesting a transfer of an amount of resources that is less than or equal to the accumulated resource amount.

2. The computing system of claim 1, wherein the instructions further configure the computing system to:
receive, at the first account and from the second account, a first transfer in the requested amount.

3. The computing system of claim 2, wherein the instructions further cause the computing system to, after receiving the first transfer:
receive, at the first account and from the second account, a second transfer, the second transfer for a further amount; and
in response to receiving the second transfer, automatically initiate a transfer to reverse the first transfer.

4. The computing system of claim 3, wherein the transfer to reverse the first transfer is made without any interaction from any operator and without permitting an account-holder for the first account to prevent the transfer to reverse the first transfer.

5. The computing system of claim 1, wherein the request-to-transfer message includes an identifier for the first account to allow for verification of the request-to-transfer message.

6. The computing system of claim 1, wherein detecting a predicted resource availability condition associated with a first account includes determining the accumulated resource amount based on:
a last date for a recurring transfer from the second account to the first account;
an amount of one or more past transfers from the second account to the first account; and
a determined period between the recurring transfers.

7. The computing system of claim 6, wherein determining the accumulated resource amount includes determining a portion of the resource transfer expected to be scheduled to occur at a future time that is attributable to current progress within the determined period.

8. The computing system of claim 1, wherein the request-to-transfer message is sent from a first financial institution system to a second financial institution system.

9. The computing system of claim 8, wherein the request-to-transfer message is a pre-staged transfer message that allows a transfer to be sent without input of a transfer amount.

10. The computing system of claim 1, wherein the instructions further configure the computing system to identify the second account by identifying an account from which a recurring transfer into the first account has previously been made.

11. A method comprising:
detecting a predicted resource availability condition associated with a first account by determining, based on a transfer history, that an accumulated resource amount associated with a resource transfer expected to be scheduled to occur at a future time is expected to be available for immediate access;
in response to detecting the predicted resource availability condition, providing a selectable interface feature at a user interface on a computing device associated with the first account, the selectable interface feature configured for inputting an early access instruction to request immediate release of at least a portion of the accumulated resource amount;
receiving the early access instruction; and
in response to receiving the early access instruction, sending a request-to-transfer message to a second account, the second account identified as being associated with the resource transfer expected to be scheduled to occur, the request-to-transfer message requesting a transfer of an amount of resources that is less than or equal to the accumulated resource amount.

12. The method of claim 11, further comprising:
receiving, at the first account and from the second account, a first transfer in the requested amount.

13. The method of claim 12, further comprising, after receiving the first transfer:
receiving, at the first account and from the second account, a second transfer, the second transfer for a further amount; and
in response to receiving the second transfer, automatically initiating a transfer to reverse the first transfer.

14. The method of claim 13, wherein the transfer to reverse the first transfer is made without any interaction from any operator and without permitting an account-holder for the first account to prevent the transfer to reverse the first transfer.

15. The method of claim 11, wherein the request-to-transfer message includes an identifier for the first account to allow for verification of the request-to-transfer message.

16. The method of claim 11, wherein detecting a predicted resource availability condition associated with a first account includes determining the accumulated resource amount based on:
a last date for a recurring transfer from the second account to the first account;
an amount of one or more past transfers from the second account to the first account; and
a determined period between the recurring transfers.

17. The method of claim 16, wherein determining the accumulated resource amount includes determining a portion of the resource transfer expected to be scheduled to occur at a future time that is attributable to current progress within the determined period.

18. The method of claim 11, wherein the request-to-transfer message is sent from a first financial institution system to a second financial institution system.

19. The method of claim 18, wherein the request-to-transfer message is a pre-staged transfer message that allows a transfer to be sent without input of a transfer amount.

20. The method of claim 11, further comprising identifying the second account by identifying an account from which a recurring transfer into the first account has previously been made.
